(19) United States
(12) Patent Application Publication
(10) Pub. No.: US 2015/0274564 A1
(43) Pub. Date: Oct. 1, 2015

(54) COASTAL WATER FACTORY AND METHODS OF USING SAME TO PRODUCE AND DISTRIBUTE POTABLE WATER AND ICE

(71) Applicants: Stephen K. Oney, Jacksonville, FL (US); Rich Treadway, Mandeville, LA (US); Ken Ostebo, Honolulu, HI (US)

(72) Inventors: Stephen K. Oney, Jacksonville, FL (US); Rich Treadway, Mandeville, LA (US); Ken Ostebo, Honolulu, HI (US)

(21) Appl. No.: 14/670,484

(22) Filed: Mar. 27, 2015

Related U.S. Application Data
(60) Provisional application No. 61/972,493, filed on Mar. 31, 2014.

(51) Int. Cl. C02F 9/00; B65D 85/72; C02F 1/50; C02F 1/22; C02F 1/44; C02F 1/32

(52) U.S. Cl. CPC C02F 9/00; C02F 1/441; C02F 1/32; C02F 1/50; C02F 1/22; B65D 85/72; C02F 2103/08

(57) ABSTRACT

An integrated ocean water processing system including a vessel, an electro/hydraulic deployment and retrieval system, a desalination system, a disinfection system, a packaging system, a freezing system capable of freezing the pouches of potable water, a water storage and dissolution system, and a distribution system capable of pumping product drinking water through a buoyant surface hose to other vessels or onshore infrastructure.

### FIELD OF THE INVENTION

The present invention is directed to systems and methods for producing potable water and ice from seawater. In particular, the systems and methods of the invention involve upstream seawater harvesting, desalination, and disinfection and downstream packaging, freezing, and distribution of the potable water obtained from the upstream processes. The systems and methods may be mobile or vessel-based and incorporate a flexible riser/submersible pump deployment/retrieval system to supply seawater from variable ocean depths for desalination. The potable water, in liquid form or frozen may be distributed vessel-to-vessel, vessel-to-shore, or a combination thereof.

### BACKGROUND OF THE INVENTION

Each year, the aftermath of hurricanes, earthquakes and drought leave thousands without clean water. Millions die from the resulting diseases. Thus, clean drinking water is the number one priority during Humanitarian Assistance/Disaster Relief (HA/DR) operations and billions of dollars are spent producing, transporting and delivering the water in massive quantities to humans in extremis. To meet HA/DR water needs, bottled water has become the most widely used initial response. Depending on the availability of useful airfield infrastructure, initial emergency stocks are flown in by aircraft, both fixed and rotary wing. However, since water weighs over 8 pounds a gallon, delivery by air is limited and expensive.

For example, U.S. Air Force C-17 cargo aircraft flying from the continental U.S. during the first days of the Haiti earthquake response in January 2010 were limited to loads of 14,000 quarts of water and 14,000 food rations (69,000 lbs. capacity). Since port facilities at Port au Prince were unusable, Coast Guard and Navy helicopters were used to airlift food, water and medicine from waiting ships that each carried a 4000-pound internal payload. If used entirely for water, each load could comprise only 133 cases of half-liter bottles. As a guide, the United Nations recommends 1 gallon (4 liters) per-person/per-day as an absolute minimum for basic survival. As such, each C-17 cargo jet provided one day's water for only 3,500 survivors and each helicopter for only 400 of Haiti's population of nearly 10 million. Based on published reports, 171 C-17 cargo aircraft were employed during the Haiti relief efforts. However, Port au Prince's population alone (2 million) would have required nearly 600 C-17 cargo aircraft per day based on the U.N.'s survival recommendations.

When air delivery is unfeasible, other more unconventional methods become necessary. As one of 33 U.S. Navy and Coast Guard ships deployed to Haiti to provide assistance, the aircraft carrier Carl Vinson was tasked to provide water from its 500,000 gallon per day desalination systems. Since most of the onboard water is still required for the crew of more than 5,000, over the course of two weeks the Carl Vinson offloaded only 87,000 gallons total of desalinated seawater for Haitian assistance. And, since operational costs of the U.S. carrier are conservatively estimated at $1 million/day, this product water reflects a possible cost of over $160 per gallon.

In total, over the first three months of the Haiti earthquake response, over 22,000 US military personnel aboard 33 ships and 321 aircraft delivered a total of 2.6 million liters of water (687,000 gallons). Since only 87,000 gallons were produced on site by the Carl Vinson, the remainder (i.e., 600,000 gallons of bottled water) had to be delivered internationally by aircraft and ship. Although the price of bottled water provided for emergency use is closely held, no estimates reflect less than $1.00 per gallon. This makes the most conservative cost of bottled water for the first three months of the Haiti relief efforts approximately $600,000 without accounting for logistics costs, e.g., associated transportation, fuel and manpower. Fuel costs alone for the 171 C-17 cargo aircraft necessary to deliver that water adds an additional $17 million (at $3/gallon jet fuel), which would bring the conservative estimate of delivered bottled water to approximately $28.30 per gallon.

Since bottled water is cumbersome and expensive, as soon as feasible, emergency agencies switch to the distribution of bulk water created by portable reverse osmosis systems, which typically arrive in the weeks and months after the initial response and are usually located within the newly established refugee camps. In fact, these camps and systems are still in place in Haiti providing long-term shelter and water until the local infrastructure can be rebuilt.

Many HA/DR events occur in the burgeoning tropical zones where a significant portion of the world's people deal with an equally significant number of its weather and tectonic events. Though much of this growing population lives on or within just a few miles of the ocean's coastlines, the ocean itself has yet to be efficiently converted into a source of clean drinking water to address needs during time of crisis.

Accordingly, there is a need in the art to provide large amounts of potable water as part of the international community's initial emergency response to HA/DR events in a new, efficient, low-cost way that reduces or eliminates the present enormous logistical and financial burdens of bottled water delivery.

### SUMMARY OF THE INVENTION

The present invention relates to systems and methods that integrate an upstream process that harvests, desalinates, and disinfects seawater with a downstream process that packages, freezes, and distributes potable water. In one embodiment, the system is at least partially based on a floating vessel. In another embodiment, a deployment/retrieval mechanism is operatively connected to the floating vessel. The deployment/retrieval mechanism may include a pump and riser. The system may include a reverse osmosis station for desalination. The reverse osmosis station may include integrated high pressure vessels.

In addition, the system may include an ultraviolet and chemical disinfection station. A quality control station may also be incorporated into the system. The disinfected and inspected water may be packaged in pouches, which may be accomplished in a pouch packaging station. Likewise, the pouches may be frozen, which may be accomplished in a pouch freezing station. In another embodiment, a distribution system may distribute the product water. The distribution system may include at least one pump and at least one hose operatively connected to each other and the vessel. In yet another embodiment, a vessel-based system may include a deployment/retrieval mechanism, a reverse osmosis station, an ultraviolet and chemical disinfection station, a quality control station, a pouch packaging station, optionally, a pouch freezing station, and a distribution system.

The system may be deployed for a predetermined length of time to variable predetermined depths in the ocean. Additional to the embodiment of a dedicated Coastal Water Factory vessel, the integrated systems incorporated in this invention can be skidded and modularized so that the equipment can be transported/shipped/flown to areas of need via standard transportation methods and configured to local vessels when available to address additional capacity requirements and expedite implementation.

### BRIEF DESCRIPTION OF THE DRAWINGS

Further features and advantages of the present invention from the following detailed description that is provided in connection with the drawings described below.

FIG. 1 illustrates the stations associated with the systems and methods of the present invention; and

FIG. 2 illustrates a vessel-based implementation of an embodiment of the present invention.

### DETAILED DESCRIPTION OF THE INVENTION

The present invention relates to systems and methods for producing potable water aboard a vessel or similar mobile implementation. In one embodiment, the systems and methods of the invention involve desalination and disinfection of harvested seawater and subsequent packaging (and optional freezing) prior to distribution. In particular, the present invention relates to systems designed to harvest seawater from variable depths, desalinate and disinfect the harvested water such that it meets municipal drinking water parameters, package the product water in various-sized containers and, optionally, freeze at least a portion of those containers. In addition, the present invention relates to methods of recycling at least a portion of the brine byproduct water for enhancement of the freezing process. The product water may be distributed in packaged form (liquid and/or frozen) and/or non-packaged form, vessel-to-vessel and/or vessel-to-shore, using the systems of the invention.

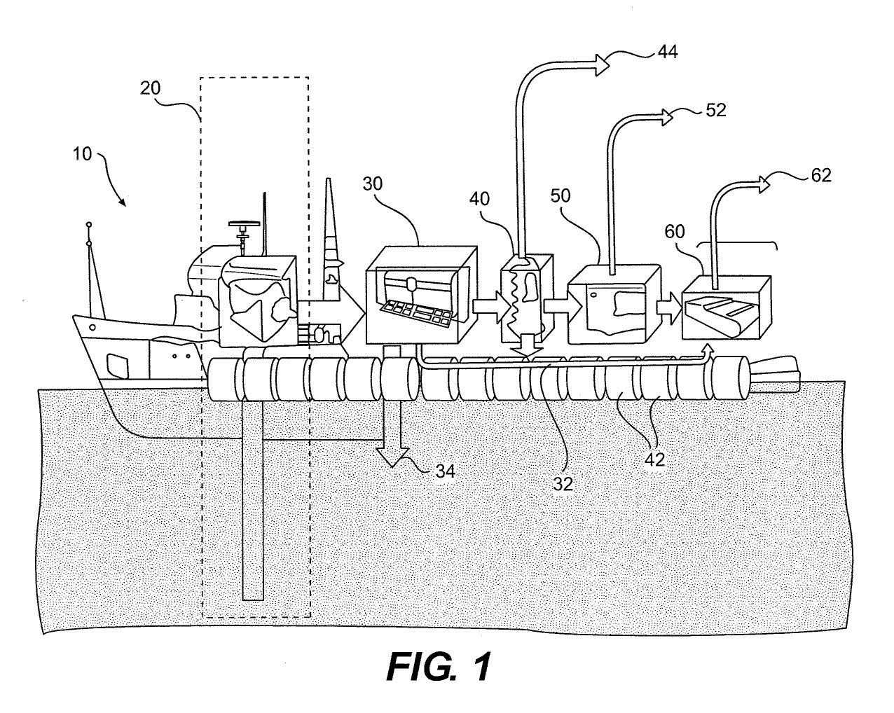

As shown in FIG. 1, the coastal water factory (CWF) may employ five separate stations that are integrated or operatively connected to each other. While FIG. 1 illustrates a floating vessel 10, the present invention contemplates other implementations where the stations are integrated. For example, the stations may be included on a plurality of floating vessels that are operatively connected to each other. In this aspect, one or more stations may be included on a first vessel, one or more stations may be included on a second vessel, and so on.

With regard to FIG. 1, floating vessel 10 may include a deployment and retrieval station 20. In one embodiment, the deployment and retrieval station has a variable depth capability. In another embodiment, the deployment and retrieval station has a fixed depth. Regardless of the variable or fixed depth, the present invention contemplates retrieval and harvesting of seawater at a depth that supports the intake of non-turbid ocean water. Without being bound to any particular theory, the non-turbid ocean water results in better harvesting than if taken from the surface layer/shallow water.

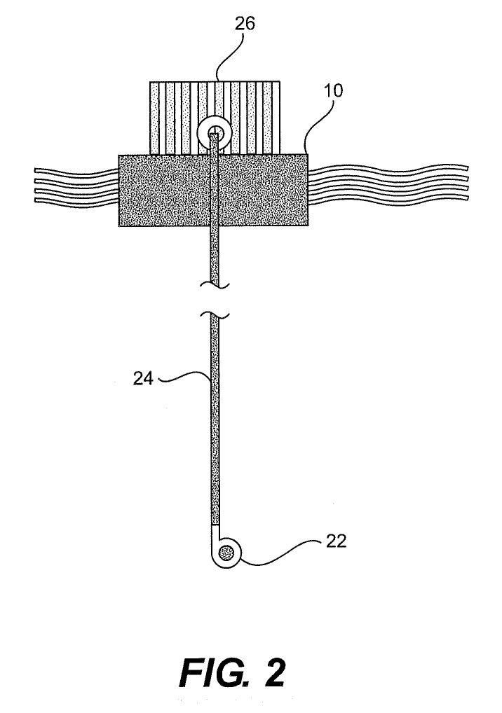

In one embodiment (generally shown in FIG. 2), the harvesting in the deployment and retrieval station 20 may occur using a submersible pump 22 that pumps the sea water into a flexible pipe or riser 24 onto the floating vessel 10 or platform, where it is transferred to the desalination station 30. In one embodiment, the flexible riser/submersible pump system is capable of harvesting seawater from variable depths down to at least about 1000 meters.

In this aspect of the invention, the deployment and retrieval station 20 may house a winch for deployment and retrieval of the riser and, optionally, the pump. Once the riser and, optionally, the pump, has been deployed to the desired depth, the pump is operated to pump seawater to the desalination station 30. Without being bound by any particular theory, the retractable option provides depth change ability for different seasons to avoid biological considerations when necessary. In this aspect of the present invention, the system may also include a positive or negative feedback system. The feedback system may include a measurement system capable of measuring ocean biology productivity. Examples of measurements of ocean biology productivity include, but are not limited to, amount of biomass, amount of sunlight, amount of nutrients, and temperature at a given depth, In response to the productivity and/or temperature measurements, the depth of the pipe or hose may be increased or decreased. For example, the depth of the pipe or hose may be decreased to harvest water with less productivity.

However, the depth from which the seawater of the present invention is extracted depends on varying factors. Regardless of the latitude, the extraction depth contemplated by the present invention is at least about 50 meters. In another embodiment, the extraction depth is about 50 meters to about 1000 meters. However, because the CWF may be used in crisis situations where the immediacy of the need is of the utmost importance, the environment aspects typically considered may be less of a factor in considering the water depth. As such, it also contemplated that the extraction depth may be less than about 50 meters in certain latitudes and/or in certain seasons. In fact, in one embodiment, the seawater may be drawn from the surface or near the surface.

In the alternative, the extraction depth may be any depth below the natural thermocline to draw from the non-productive region of the ocean. For example, in one embodiment, the extraction depth may be at least about 100 meters in high latitude locations or in mid latitude locations during winter. In this aspect, the extraction depth may be from about 100 meters to about 1000 meters. In another embodiment, the extraction depth may be at least about 250 meters. In this aspect, the extraction depth may be from about 250 meters to about 1000 meters.

In one embodiment, the extraction may occur using the method of sea water extraction disclosed in U.S. Pat. No. 7,658,843, the entire disclosure of which is incorporated by reference herein.

The CWF may also include a desalination station. For example, as shown in FIG. 1 a desalination station 30 may be housed on the floating vessel 10 downstream of the deployment and retrieval station 20. The desalination station 30 may include a reverse osmosis system. As would be understood by those of ordinary skill in the art, reverse osmosis is a method of separating fresh water from sea water by forcing the collected sea water through an impermeable membrane wherein the brine concentrate is left behind. In this aspect of the invention, two fluids result from the desalination station 30: (1) product water containing less than 1000 parts per million (ppm) Total Dissolved Solids (TDS) and (2) brine by-product containing more than 35,000 ppm TDS. As such, the desalination station 30 may include at least one impermeable membrane, at least one output for the brine by-product, and at least one output for the product water resulting from the reverse osmosis process. In particular, the product water may be separately directed to (1) the disinfection station 40 and (2) dissolution of brine by-product before reintroduction to the open ocean. In particular, the CWF may maintain onboard storage tanks capable of holding variable amounts of product water from the desalination station 30 that are used for dissolution of brine by-product before reintroduction to the ocean (shown as 34 in FIG. 1).

The desalination station may process up to 500,000 gallons of potable water from the harvested seawater per day. In one embodiment, the CWF includes at least one desalination station. In another embodiment, the CWF includes a plurality of desalination stations. For example, a CWF in accordance with the present invention may include at least two desalination stations each capable of processing up to 500,000 gallons of potable water from the harvested seawater per day.

The CWF may also include a disinfection station 40. In one embodiment, the product water created by reverse osmosis in the desalination station 30 may be disinfected using redundant techniques. For example, the disinfection station 40 may include the exposure of the product from the desalination station 30 to ultra violet light and/or sodium/calcium hypochlorite in dosages necessary to render inert all bacterial and viral elements. In another embodiment, the disinfection station 40 may include any other suitable commercial disinfectant systems that render inert all bacterial and viral elements. A quality control laboratory on the vessel (not shown) is contemplated to ensure product water meets necessary local and international standards for consumption.

As shown in FIG. 1, in one embodiment, the disinfection system 40 may be housed on the floating vessel 10 downstream of the desalination station 30. The disinfection station is connected to storage tanks 42. In one embodiment, the storage tanks have the capacity to hold at least about 500,000 gallons of potable water. In another embodiment, the storage tanks have the capacity to hold at least about 750,000 gallons of potable water. In yet another embodiment, the storage tanks have the capacity to hold at least about 1,000,000 gallons of potable water. In still another embodiment, the storage tanks have the capacity to hold about 1,500,000 gallons of potable water. The storage tanks may be connected to a distribution system for delivery of potable water to an intended destination. The intended destination may be a second floating vessel or platform, an on-shore receiving vessel, or a combination thereof.

The disinfection station 40 has the capability of producing up to about 500,000 gallons of potable water per day. In one embodiment, at least about 750,000 gallons per day of potable water are realized from the disinfection station. In another embodiment, the disinfection station 40 has the capability of producing up to about 1 million gallons of potable water per day, which can be pumped to (i) the intended destination, (ii) the storage tanks 42, and/or (iii) the packaging station.

In particular, the present invention also relates to the ability to distribute potable water exiting the disinfection station 40 in bulk. In one embodiment, the distribution system (shown generally as 44 in FIG. 1) includes a hose, a barge, or other means to transfer the potable water from the disinfection station 40 to another vessel and/or shore. For example, the potable water may pass through a buoyant flexible hose from the CWF to vessels lying alongside. In another embodiment, potable water may pass through a buoyant flexible hose from the CWF to infrastructure ashore capable of water distribution or storage. In both embodiments, the power and pressure necessary to move the potable water in bulk from vessel to vessel or vessel to shore, may be provided by integrated systems.

The packaging station 50 may be downstream of the disinfection station 40. The potable water transferred to the packaging station 50 may be less than 100 percent of the output from the disinfection station 40 because, as discussed above, at least a portion of the potable water from the disinfection station 40 may be transferred in bulk to an intended destination 44 separate from the vessel and/or the storage tanks 42.

The packaging station 50 provides the system the ability to package potable water from the disinfection station 40 in variously sized containers. In one embodiment, package sizes may range from about 0.5 liter pouches to about 5 liter pouches for personal consumption. For example, the personal consumption packages may range from about 2 liters to about 3 liters. In one embodiment, the personal consumption package sizes may be manufactured mechanically and filled aboard the vessel. For example, it is contemplated that large rolls of plastic may be heat sealed around the edges (with the exception of one portion left unsealed for filling) in the packaging station 50 to create the personal consumption packages. After the potable water is loaded into the personal consumption packages, the unsealed portion may be sealed and perforated. The perforated area may be used for ease of carrying, ease of opening for drinking, or both.

In another embodiment, package sizes range from about 1000 liter “cubes” to about 20,000 liter bladders. In contrast to the personal consumption packages, the larger cubes and bladders may be stored aboard and filled off vessel or ashore using the bulk distribution system. In one embodiment, the cubes and bladders may be stored in containers for ease in stacking, offloading, and transport via train or truck once offloaded on shore.

In one embodiment, the packaging station 50 may package about 50,000 gallons per day of potable water. In another embodiment, the packaging station 50 may package about 100,000 gallons per day of potable water. In still another embodiment, the packaging station 50 may package about 200,000 gallons per day of potable water.

The CWF may also include a freezing station 60 operatively connected to and downstream of the packaging station. As shown in FIG. 3, the freezing station 60 may receive packaged potable water from the packaging station 50 aboard the floating vessel 10. In this aspect of the invention, freezing systems include, but are not limited to, brine freezing, plate freezing, nitrogen immersion freezing, tunnel freezing, and combinations thereof. If the freezing station employs brine freezing, at least a portion of the brine by-product exiting the desalination station 30 may be transferred to the freezing station 60 via pipe 32. The freezing systems would be used to create freezing temperatures below normal freezing point (0° Celsius). Frozen packets may then be assembled on pallets for trans-loading off of the vessel. Without being bound by any particular theory, the present invention contemplates the ability to freeze the personal consumption packages (i.e., the 0.5-5 liter pouches) to support the storage and maintenance of perishable items like food and medicine. In another embodiment, it is contemplated that, once melted, the frozen personal consumption packages (i.e., 0.5-5 liter ice packets), may be used for its original purpose of personal water consumption.

Each station/system may have multiple sub-processes and components, which are contemplated to be integrated for use in differing combinations to support production and distribution of various drinking water products as well as brine water by-product dissolution. For example, the present invention contemplates modularized stations that may be shipped/flown to crisis areas for integration and fixing to local vessels with suitable deck space should a dedicated CWF not be available in region of need.

In one embodiment, the system of the invention is offshore. For example, should the system be deployed to a coastline recently devastated by a natural disaster, the CWF may maintain position offshore using an onboard mooring or positioning system to harvest water from a depth necessary to achieve non turbid seawater that ultimately results in product water distributed ashore using buoyant flexible hoses. The stations shown in FIG. 1, i.e., the deployment and retrieval station, the desalination station, the disinfection station, the packaging station, the freezing station, and the distribution system, are integrated to deliver potable water in bulk and/or in packaged form (liquid and/or frozen). If the potable water is delivered ashore in packaged form, trans-loading of palletized, pouched ice or water may be powered by independent, onboard electric generation. In this aspect, all or most necessary provisions for the crew and process operations for many weeks may be maintained on board along with quality control and laboratory requirements. Additionally, the CWF may be configured to operate as a base for communications and coordination of humanitarian efforts should it be required.

In another embodiment, the system of the invention is located next to shore or at port. In this configuration, the system would still perform all functions using coastal or port water.

In yet another embodiment of the invention, the system of the invention would harvest clean raw water offshore, process and store bags and ice in bulk, and return to shore for offload and distribution. The system may also include a mooring/anchor system.

The invention described and claimed herein is not to be limited in scope by the specific embodiments herein disclosed, since these embodiments are intended as illustrations of several aspects of this invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. For example, the application of the current invention is not limited to just HA/DR applications. Indeed, the ability to create fresh water in a cost-effective manner offshore can be utilized in other commercial applications that require large quantities of raw, fresh, or brine water offshore or at coastal locations. Non-limiting examples of potential applications include, but are not limited to, applications requiring large amounts of fresh water such as aquaculture, agriculture, cement manufacture, and combinations thereof.

1. An integrated ocean water processing system comprising:
a vessel with the deck space, storage capacity, electric power capacity, heavy lift (crane) capacity and crew capacity capable of independent coastal operations;
an electro/hydraulic deployment and retrieval system capable of deploying a submersible pump and hose to variable depths from the ocean surface to about 1000 meters depth or more;
a desalination system capable of producing product water comprising no more than about 1000 ppm total dissolved solids;
a disinfection system capable of rendering inert all water borne bacterial and viral contamination in the product water to produce potable water;
a packaging system capable of mechanically producing up to about 5 liter pouches of potable water;
a freezing system capable of freezing the pouches of potable water;
a water storage and dissolution system capable of diluting brine by-product before release back into the ocean; and
a distribution system capable of pumping product drinking water through a buoyant surface hose to other vessels or onshore infrastructure.

2. A method of converting seawater into potable water comprising:
providing a deployment and retrieval station capable of harvesting seawater from ocean depths of at least about 50 meters;
providing a desalination station capable of reducing the total dissolved solids of the harvested seawater to produce product water, wherein the product water comprises less than 1000 ppm in total dissolved solids;
providing a disinfection station capable of rendering inert all product water borne bacterial and viral contamination to produce potable water;
providing a packaging station capable of mechanically producing personal consumption pouches of the potable water, wherein the personal consumption pouches comprise up to about 5 liters of potable water;
providing a freezing station capable of freezing the personal consumption pouches; and
providing a distribution station capable of pumping potable water from the disinfection station to an intended destination.

3. The method of claim 2, further comprising integrating the deployment and retrieval station, the desalination station, the disinfection station, the packaging station, the freezing station, and the distribution station on a vessel.

4. The method of claim 3, wherein the intended destination is at least one other vessel, an onshore infrastructure, or a combination thereof.

5. The method of claim 2, further comprising the step of providing a water storage and dissolution station capable of diluting brine by-product from the desalination station before release back into the ocean.
